(19) United States
(12) Patent Application Publication
(10) Pub. No.: US 2019/0057338 A1
(43) Pub. Date: Feb. 21, 2019

(54) RECOMMENDING TEAM COMPOSITION USING ANALYTICS

(71) Applicant: INTERNATIONAL BUSINESS MACHINES CORPORATION, Armonk, NY (US)

(72) Inventors: Adi I. Botea, Dublin (IE); Alice J. Chang, New York, NY (US); Elizabeth M. Daly, Monkstown (IE); Raymond Lloyd, Navan (IE); Xiaoxi Tian, Brooklyn, NY (US)

(21) Appl. No.: 15/679,797

(22) Filed: Aug. 17, 2017

(51) Int. Cl. G06Q 10/06; G06Q 10/10; H04L 29/08; G06F 17/30

(52) U.S. Cl. CPC G06Q 10/063112; G06Q 10/1053; G06Q 10/06398; G06F 17/3053; H04L 67/306

(57) ABSTRACT

A method, computer system, and a computer program product for building a team to work on an opportunity is provided. The present invention may include receiving an opportunity signature based on the opportunity. The present invention may include determining a plurality of team roles. The present invention may include selecting a role to fill from the determined plurality of team roles. The present invention may include determining a plurality of candidates, wherein the plurality of candidates includes a plurality of candidate evidence data. The present invention may include selecting a candidate based on the plurality of candidate evidence data. The present invention may include assigning the selected candidate to fill the selected role. The present invention may include iteratively selecting at least one additional role and at least one additional candidate to fill the selected at least one additional role on the team until a stopping criterion is met.

### BACKGROUND

The present invention relates generally to the field of computing, and more particularly to analytics.

Project success and efficiency often depends on the team or personnel formed and the team dynamics involved. Team dynamics include factors such as skills, experience, location and proximity, client relationships, history of working together, and social relationships. Finding the right people to harmoniously work together may be a challenge given high turnover and skill sets may evolve quickly as the team's goals rapidly change.

### SUMMARY

Embodiments of the present invention disclose a method, computer system, and a computer program product for building a team to work on an opportunity. The present invention may include receiving an opportunity signature based on the opportunity. The present invention may also include determining a plurality of team roles based on the received opportunity signature. The present invention may then include selecting a role to fill from the determined plurality of team roles. The present invention may further include determining a plurality of candidates based on the selected role, selected role evidence data, and the received opportunity signature, wherein the plurality of candidates includes a plurality of candidate evidence data. The present invention may also include selecting a candidate from the determined plurality of candidates based on the plurality of candidate evidence data. The present invention may then include assigning the selected candidate to fill the selected role on the team. The present invention may further include iteratively selecting at least one additional role and at least one additional candidate to fill the selected at least one additional role on the team until a stopping criterion is met.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for recommendation model formation according to at least one embodiment;

FIG. 3 is an operational flowchart illustrating a process for recommendation model usage according to at least one embodiment;

FIGS. 4A and 4B illustrate an exemplary team building model usage scenario according to at least one embodiment;

FIG. 5 is a block diagram of internal and external components of computers and servers depicted in FIG. 1 according to at least one embodiment;

FIG. 6 is a block diagram of an illustrative cloud computing environment including the computer system depicted in FIG. 1, in accordance with an embodiment of the present disclosure; and

FIG. 7 is a block diagram of functional layers of the illustrative cloud computing environment of FIG. 6, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As described previously, project success and efficiency often depends on the team or personnel formed and the team dynamics involved. Team dynamics include factors such as skills, experience, location and proximity, client relationships, history of working together, and social relationships. Finding the right people to harmoniously work together may be a challenge given high turnover and skill sets may evolve quickly as the team's goals rapidly change.

Therefore, it may be advantageous to, among other things, provide a way to recommend team composition based on analyzing project needs, the characteristics of available team members, and social network connections of available team members to iteratively build a team that fills in gaps and satisfies the parameters of the project.

The following described exemplary embodiments provide a system, method and program product for recommending team composition. As such, the present embodiment has the capacity to improve the technical field of analytics by analyzing project needs and available team members to iteratively build a team that fills gaps in opportunity requirements. More specifically, roles may be identified for an opportunity or project together with expertise relevant for fulfilling the opportunity. Then, incrementally and iteratively, a user may build a team based on the combination of social relationships to each other as a team and the expertise and skills the members provide to fulfill the parameters of the opportunity.

According to at least one embodiment, input may be received by a system, whereby the input includes an opportunity (i.e., project) having a set of properties, historical data of previous opportunities, and team member properties (i.e., team member data). Then, the system generates team member profiles capturing properties such as relationships, knowledge relevant to the opportunity, social relationships, and performance. The system may then identify roles that may be used to fulfill the parameters of the opportunity. Thereafter, the identified roles may be ranked based on, for example, a role's importance in successful previous opportunities and a role may be selected from the ranked identified roles to fill. Finally, the system, or a user, iteratively selects team members to build a team until a stopping criterion is satisfied. The opportunity's properties may be defined as a signature that, for example in a sales scenario, includes a client identifier (ID), client location, client or opportunity business domain, products and services of interest, and current team owner.

Team member profiles may also contain data related to the team member's history in previous opportunities including the team member's role, the outcome of the previous opportunity (e.g., success or failure), and the previous opportunity's signature. Team member history may additionally include data describing how various team members worked together (with other people within the pool of available team members or with other people outside the pool of available team members) in previous opportunities.

Additionally, workloads for team members may be projected and the projected workload may further be dynamically adjusted after the members are assigned to the team, based on expected workload. Furthermore, the system may receive social network profile information for the people within the pool of available team members and then query, search, and retrieve social link data from remote servers via a communication network (or locally). Thereafter, the social link data may be analyzed to identify which people within the pool of available team members may already be linked within the social network.

According to at least one embodiment, the system may take as inputs opportunity parameters and team member parameters corresponding to people within the pool of available team members. The opportunity parameters may, for example, include a client ID, a client location, a client/opportunity business domain, products, and a current team owner. According to at least one other embodiment, additional parameters may be identified as having an impact on the selection process and may be included. Team member parameters may include a location, data indicating history with the client, data indicating history with business domains, data indicating history of performance (e.g., success or failure), roles the person has filled previously, social relationships from prior projects, and skills and expertise.

After receiving input parameters, the system may then analyze the opportunity parameters to identify relevant job roles to assign. Thereafter, a weighted list of relevant roles may be generated and ordered based on assigned weight. The weighted list of relevant roles may then be presented to the user and the user may select the role to fill. Alternatively, the highest weighted role in the list (e.g., line item owner) may be automatically selected for filling by the system. Next, a list of persons to fill the selected role may be generated and ranked based on the characteristics of the available team members. The list of available team members may be presented to the user and the user may select a team member to fill the previously selected role.

According to at least one other embodiment, based on the input opportunity parameters, the characteristics of the current team members may be scored within identified categories related to the opportunity (e.g., product knowledge, performance, and social contacts). After scoring the characteristics of the current team members, categories that are more deficient relative to other categories may be identified and targeted. Then the system may analyze the pool of available team members using the input team member parameters to find the best person to fill the previously identified role (e.g., line item owner) based on the characteristics of the person which may be ranked highest compared to the other candidates for the identified role.

After a candidate has been selected to fill the role, the team member selected from the pool of available team members may be added to the current team, the selected team member may be removed from the pool of available team members, and scores representing the characteristics of the current team may be recalculated by category before repeating the process to select the next relevant role to fill. If there is a possibility to have additional team members filling the same role (e.g., two system architects) the role may remain on the list of relevant roles for future iterations. Otherwise, the role may be removed from the list of relevant roles. Subsequent iterations may be used to progressively fill the team until a stopping criterion is met, such as when a user is satisfied with the composition of the team.

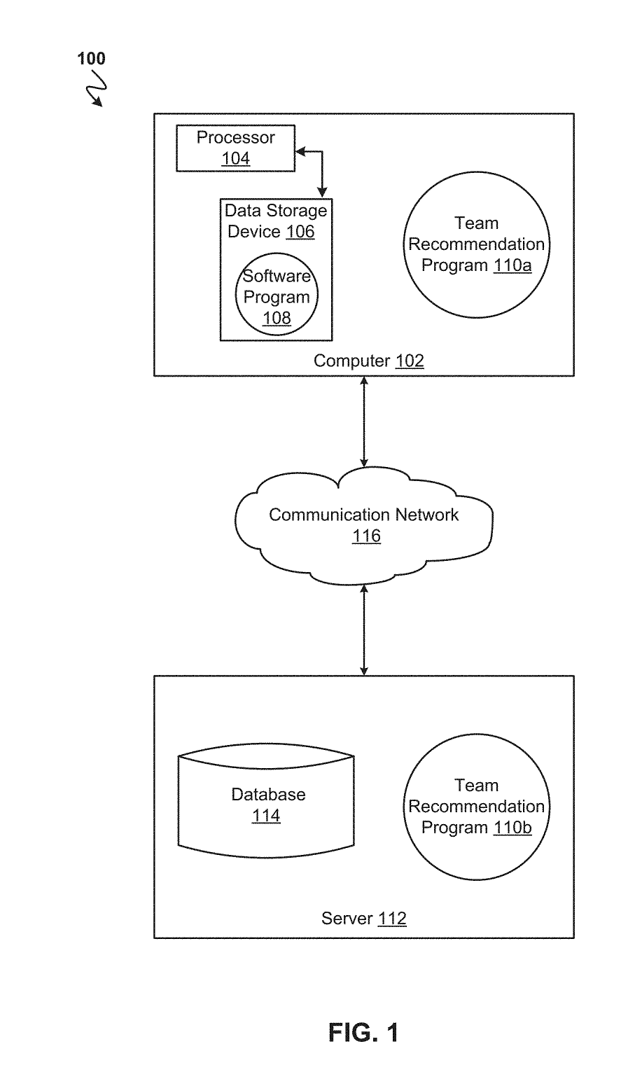

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a team recommendation program 110a. The networked computer environment 100 may also include a server 112 that is enabled to run a team recommendation program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

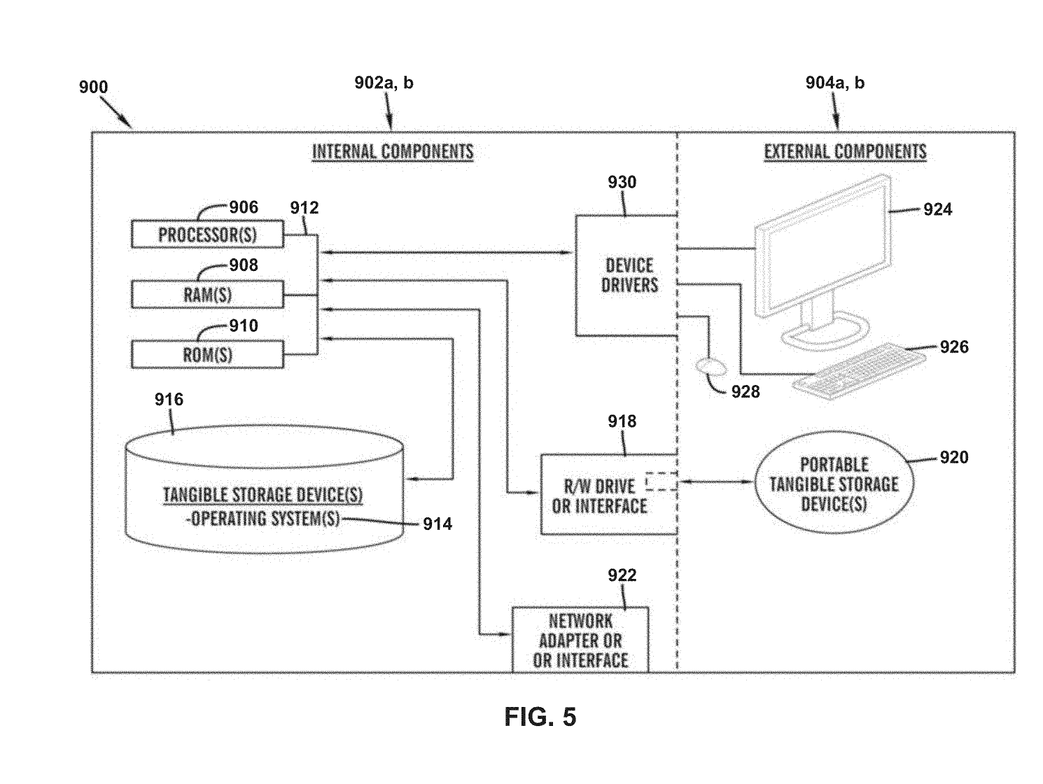

The client computer 102 may communicate with the server computer 112 via the communications network 116. The communications network 116 may include connections, such as wire, wireless communication links, or fiber optic cables. As will be discussed with reference to FIG. 5, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the team recommendation program 110a, 110b may interact with a database 114 that may be embedded in various storage devices, such as, but not limited to a computer/mobile device 102, a networked server 112, or a cloud storage service.

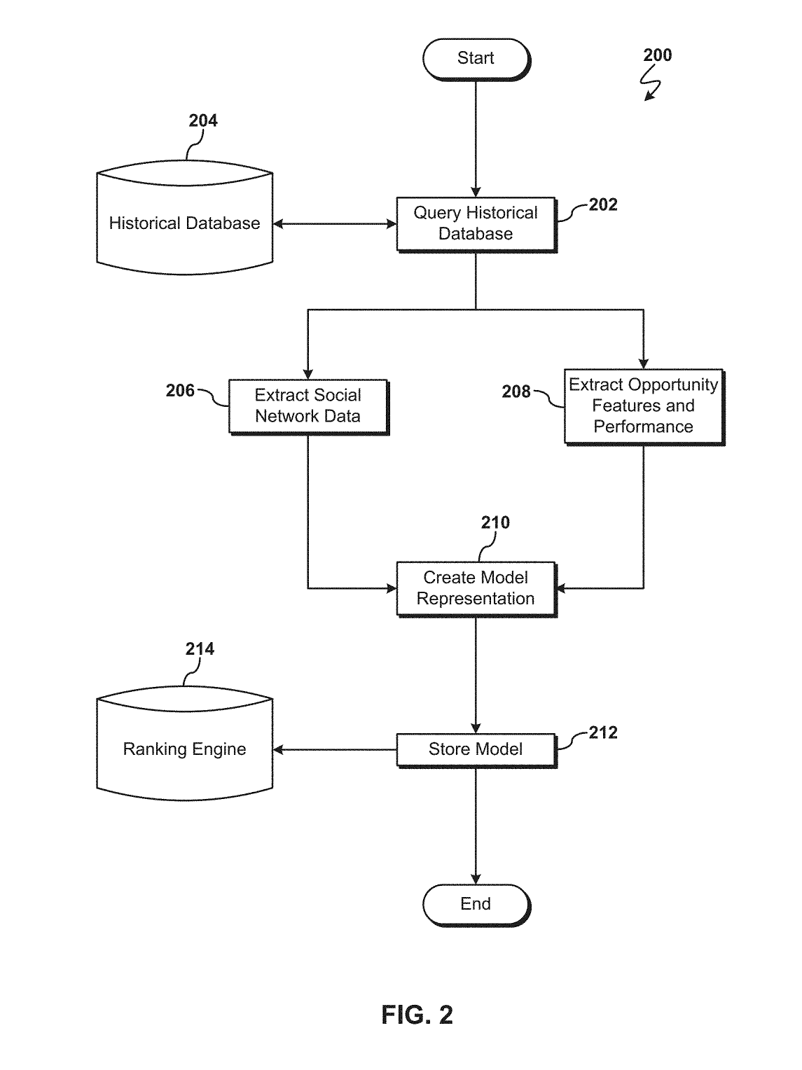

According to the present embodiment, a user using a client computer 102 or a server computer 112 may use the team recommendation program 110a, 110b (respectively) to iteratively select team members based on team member characteristics and social network data to fill a team tailored for a specific opportunity or project. The selected team members may then form the basis for the recommended team composition. The team recommendation method is explained in more detail below with respect to FIGS. 2-4.

Referring now to FIG. 2, an operational flowchart illustrating the exemplary recommendation model formation process 200 used by the team recommendation program 110a and 110b according to at least one embodiment is depicted.

At 202, a historical database 204 (e.g., database 114) is queried to retrieve data relating to persons involved with prior opportunities. A list of prior opportunities (e.g., sales opportunities or other team projects) may be generated or received by the recommendation model formation process 200. From the list of prior opportunities, a list of persons involved with those opportunities may be created. Thereafter, a query may be generated to retrieve data (i.e., prior opportunity data) relating to the sellers (i.e., team members or persons) involved with the opportunities identified within the list of prior opportunities by the recommendation model formation process 200 and transmitted to a relational database, such as the historical database 204. According to at least one other embodiment, data resulting from the query may be cached, in whole or in part, in another storage system for performance benefits while building the model (e.g., an evidence-based model). The query may be generated to conform to the input format used by the historical database 204 to create a compatible query. More specifically, the query may request opportunity data describing the opportunities the sellers have been involved with previously (including opportunities not included in the original list of prior opportunities). Queries to the historical database 204 may be transmitted via a communication network 116 to the server 112 controlling the historical database 204 in instances where the historical database 204 may be on a separate device apart from the computer 102 or server 112 running the team recommendation program 110a and 110b. Later, the results of the query may be received via the communication network 116. Opportunity data may include who filled the roles for opportunities, the products involved with the opportunity, the location of the team members, data indicating the success or failure of the opportunity, the client involved in the opportunity, and other opportunity-related data.

For example, a list of prior sales opportunities is generated that includes opportunity O₁, opportunity O₂, and opportunity O₃. A query may then be sent to the historical database 204 to retrieve the sellers involved with opportunities O₁-O₃. The query results may indicate that Doug, Jane, Nicole, Jim, and Todd worked on at least one of opportunity O₁, opportunity O₂, or opportunity O₃. Thereafter, the historical database 204 is queried to find the opportunities that Doug, Jane, Nicole, Jim, and Todd worked on and attendant opportunity data.

At 206, social network data is extracted from the received opportunity data. Social network data may be extracted from the opportunity data based on the sellers or other persons involved with a prior opportunity. Continuing the previous example, based on the opportunity data, Todd worked on opportunity O₂ with Jane and Doug and opportunity O₄ with Jane and Maggie. Thus, Todd's social network will include Jane, Doug, and Maggie. Furthermore, additional levels of the social network may be extracted and added to a seller's social network by adding the social networks of the other sellers to the original seller's social network. Continuing the above example, an additional social network level is added to Todd's social network by incorporating the social network of Jane. Thus, if Jane has Martin, Doug, Mary, and Jill in her social network, Todd's social network will add Martin, Mary, and Jill (i.e., the people in Jane's social network that are not already in Todd's social network). The same process may continue for the other members of Todd's social network to build the second level of the social network. In like manner, additional social network levels may be added to the original seller's social network.

At 208 opportunity features and performance data is extracted from the received opportunity data. From the previous opportunity data stored in the historical database 204, the features of an opportunity and the resulting success of the opportunity may be extracted. Opportunity features (i.e., opportunity feature data) may include the products involved, the people involved in the opportunity and their roles, the industry and sector involved, the client, the client location, the team's location, and the like. The opportunity data may be stored in the historical database 204 and organized in the subsequent retrieved data by opportunity. Continuing the previous example, opportunity features and performance data are extracted from the opportunities (i.e., O₁-O₄) associated with the original list of people (i.e., Doug, Jane, Nicole, Jim, and Todd). From opportunity O₂, the features may include a sector of financial services, an industry of banking, a client C, a client location of Canada, and products involved including Cloud Services and Statistics Module. The sellers and roles extracted from the opportunity data from O₂ may include Todd as Client Representative, Jane as Software Architect, and Doug as Line Item Owner. The extracted opportunity performance for O₂ may be success. In like manner, the opportunity features, sellers, roles, and performance data may be extracted for the remaining opportunities (i.e., O₁, O₃, and O₄).

According to at least one embodiment, opportunity features and performance data may be extracted at 208 concurrently with extracting social network data at 206. According to at least one other embodiment, extracting opportunity features and performance data at 208 may occur before or after extracting social network data at 206.

Next, at 210, a model representation is created based on the extracted data. A model may be created whereby opportunity data may be organized by seller. For example, the opportunity data from opportunities O₂ and O₄ extracted before at 208 may be linked to Todd or added to an entry for Todd. Furthermore, Todd's social network data extracted at 206 may also be added to the entry for Todd in the created model. The model representation may be embodied as textual data.

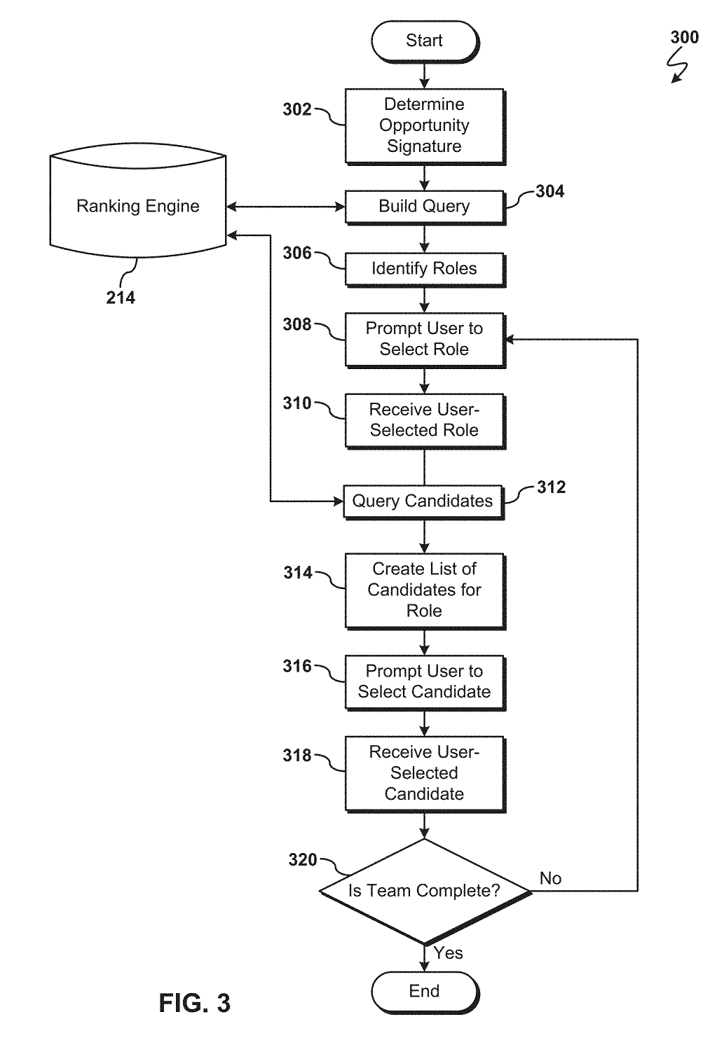

Then, at 212, the created model is stored in an evidence-based ranking engine 214. The textual data forming the model representation created previously at 210 may be added to (i.e., stored in) a search platform, such as Apache Solr™ (Apache Solr and all Apache Solr-based trademarks and logos are trademarks or registered trademarks of the Apache Software Foundation and/or its affiliates) for subsequent searching by the recommendation model usage process which will be described in greater detail below with respect to FIG. 3. The search platform may store the model in a data repository, such as a database 114. The data repository may be located apart from the computer 102 or server 112 running the team recommendation program 110a and 110b and may be accessed by the team recommendation program 110a and 110b via a communication network 116.

Referring now to FIG. 3, an operational flowchart illustrating the exemplary recommendation model usage process 300 used by the team recommendation program 110a and 110b according to at least one embodiment is depicted.

At 302, an opportunity signature is determined for the current opportunity. The opportunity signature may include the features of the current opportunity for which a team is being assembled. The features of the current opportunity may include information similar to the opportunity features of prior opportunities described previously, such as sector, industry, client, location, and products involved. The opportunity signature may be received as user input or derived automatically. In the case of user input, a user interface may be implemented in, for example, JavaScript® (JavaScript and all JavaScript-based trademarks and logos are trademarks or registered trademarks of the Oracle Corporation and/or its affiliates) that provides a way for a user to input opportunity features as text through text fields, drop down lists, and the like. The user interface may be displayed by the user's computer 102 through a local software program 108, such as a web browser in the case of a web-based interface, that may display the user interface and collect the subsequent responses from the user. The collective responses from the user as entered in the user interface may constitute the opportunity's signature or features and may then be sent to the server 112 or other device running the team recommendation program 110a and 110b. Automatic opportunity signature determination may be implemented through analysis of a database 114 or other storage containing available opportunities and the data (i.e., features) describing the opportunities.

For example, a web-based interface may be presented to the user as part of the team recommendation program 110a and 110b. The interface may include text boxes for user input. Multiple text boxes may be used to collect data including the opportunity name, the sector, the industry, the name of the lead person or team owner for the opportunity, the client, and the products involved. If Jill is the user, Jill may enter “Bank B” as the opportunity name, “Financial Serves” as the sector, “Banking” as the industry, “Jill” as the team owner, “Bank B” as the client, and “Cloud Services” and “Statistics Module” as the products into the interface. Thereafter the interface may collect the entered text and organize the text into a predefined format as an opportunity signature for the current opportunity. The opportunity signature may then be transmitted via a communication network 116 to a server 112 running the team recommendation program 110a and 110b.

Next, at 304, a query is built for searching the model stored in the ranking engine 214. The query may begin as a string based on the opportunity signature determined previously at 302. The query may be built and formatted according to the syntax dictated by the ranking engine 214. Additionally, the query may be built to request data related to prior opportunities that may be similar to the current opportunity based on the current opportunity's signature. After building the query, the query may be transmitted to the ranking engine 214 via a communication network 116. The ranking engine 214 may process the query, search the model representation based on the query, and return the results of the query to the team recommendation program 110a and 110b. Queries to the ranking engine may utilize Java® (Java and all Java-based trademarks and logos are trademarks or registered trademarks of the Oracle Corporation and/or its affiliates) Representational State Transfer (REST) application programming interfaces (APIs). If the query results are too restrictive due to the constraints (i.e., parameters), another query may be generated whereby some of the constraints may be relaxed (e.g., revise the query to include any sector) or granularity may be increased (e.g., product levels) to produce results with sufficient content.

Then, at 306, relevant job roles for the current opportunity are identified. From the results of the query, data related to the current opportunity may be returned. Within the related data may be data regarding previous opportunities that may be similar to the current opportunity. The job roles that were part of the teams that worked on similar opportunities in the past may be identified and collected to form a list of job roles. Then, the job roles may be ranked based on a weight assigned to each role. The weights assigned to the roles may be calculated based on the success of the previous opportunities. For example, if many successful previous opportunities had a Line Item Owner role and only few successful previous opportunities had an Associate Opportunity Owner role, then the Line Item Owner role would be weighted higher relative to the Associate Opportunity Owner role in the list of roles. A list of relevant job roles may then be generated, for example, as a subset of the list of roles with weights above a threshold value. Subsequent iterations may remove job roles from the list of relevant job roles as team members are selected to fill job roles as will be described in further detail below.

At 308 the list of relevant job roles is presented to the user and the user is prompted to select a role to fill in the team for the current opportunity. The user may be presented with the list of relevant job roles within an interface, such as a web-based interface. The list of relevant jobs may be transmitted to the user's computer 102 via the communication network 116 and presented using a software program 108, such as a web browser. The list of relevant job roles may be displayed along with a numerical, visual (e.g., color, shape, size, or font), or other indication of the weight assigned to the job role. Thereafter, the user may interact with the presented list (e.g., through a mouse click or tapping on a touchscreen) to select a job role to fill.

Next, at 310, the team recommendation program 110a and 110b receives data indicating the job role the user selected in response to the presented list of relevant job roles. Once the user selects a job role, the resulting selection may be transmitted to the team recommendation program 110a and 110b via the communication network 116.

At 312, the model stored in the ranking engine 214 is queried based on the user-selected role. Once the user has selected a role to fill, a query may be generated to retrieve candidates and candidate evidence data for filling the selected role. Candidate evidence data may include historical data indicating the candidate's prior experience and successes in prior opportunities (e.g., products the candidate worked with, roles the candidate had, successes, and social network). According to at least one embodiment, the query may specifically target sellers that have held the job role selected or meet predefined criteria indicating the seller may be successful in the role without having held the role before. The query may be transmitted to the ranking engine 214 as described previously and the query results may be returned containing candidate sellers and the evidence data for the candidate sellers. For example, if the user selected Line Item Owner as the role to fill, a query will be generated to identify and retrieve candidate sellers for filling the Line Item Owner role. The team recommendation program 110a and 110b will then transmit the query to a server 112 administering the ranking engine 214 over a communication network 116. The server 112 will then query the ranking engine 214 using the received query and thereafter the results of the query produced by the ranking engine 214 are transmitted to the computer 102 running the team recommendation program 110a and 110b over the communication network 116.

Then, at 314, a list of candidate sellers is created for filling the user-selected job role. Using the results from the query that includes the seller data corresponding with previous opportunities as described above with respect to FIG. 2, a pool of sellers may be determined. The pool of sellers (i.e., team member candidates) may be ranked based on evidence related to the features of the current opportunity and previous successes. More specifically, the number of successful opportunities a candidate seller has worked on that involved a product in the current opportunity may be scored. Totals for the amount of successful opportunities overall and the amount of times the candidate seller has performed the role selected for filling may also be calculated. Additionally, using social network data extracted earlier, the number of times the candidate seller worked directly with members of the current seller team selected for the current opportunity in the course of previous opportunities may be determined. Similarly, the number of times a candidate seller worked indirectly with members of the current team selected for the current opportunity in the course of previous opportunities may be determined using social network data. Working indirectly with members of the current seller team may include the number of sellers a candidate seller has worked with that have worked directly with members of the current seller team. Based on the numerical values determined for the candidate sellers, the list of candidate sellers may be ranked and sorted based on the rank. The candidate sellers may be ranked based on the scores corresponding with the evidence for individual candidate sellers and comparing the score values for the candidate sellers.

At 316, the user is prompted to select a candidate seller to add to the team. The user may be presented with the list of candidate sellers within an interface, such as a web-based interface. The list of candidate sellers may be transmitted to the user's computer 102 via the communication network 116 and presented using a software program 108, such as a web browser. The list of candidate sellers may, for example, be displayed in ranked order with the highest ranked candidate first. Furthermore, candidate sellers with ranked values below a threshold value may be excluded or the top X candidates may be shown (where X is a predefined value). Thereafter, the user may interact with the presented list (e.g., through a mouse click or tapping on a touchscreen) to select a candidate seller to fill the selected job role.

According to at least one embodiment, the user may also have the option to adjust the weight of evidence categories. For example, if the user decides that knowledge of the “Statistics Module” product is important for filling a role (or for the team in general), the user may add more weight to that category. Thus, candidates with more experience in successful opportunities involving the “Statistics Module” product may be ranked higher as the evidence score for that category is boosted. If the user sets the weight of the “Statistics Module” product category to a weight of 10, the evidence values for the candidate sellers in that category may be multiplied by 10 and the list may be re-ranked and subsequently reordered. User adjustments to category weight may be logged and tacked to determine weight adjustments over time to later suggest to the user that, based on the history of prior adjustments, the user may wish to adjust the category weights accordingly. Alternatively, the team recommendation program 110a and 110b may automatically adjust weights based on historical adjustments or projected adjustment trends based on the historical adjustment data.

Next, at 318, the team recommendation program 110a and 110b receives data indicating the candidate seller the user selected to fill the previously selected job role in response to the presented list of candidate sellers. Once the user selects a candidate seller, the resulting selection may be transmitted to the team recommendation program 110a and 110b via the communication network 116. Thereafter, the selected candidate may be assigned to the current seller team and the selected candidate may be assigned to the selected job role. Furthermore, the selected candidate may be removed from consideration for filling additional roles within the team.

At 320 the team recommendation program 110a and 110b determines if the team is complete. The team recommendation program 110a and 110b may determine that the team is complete based on receiving data from the user indicating that the team is complete or automatically based on a stopping criterion. According to at least one embodiment, the user may indicate the team is complete by interacting with an interface feature, such as button designated to indicate when the team is complete. For example, a web-based interface may include a button within a dialog box that is presented to the user after selecting a candidate asking if the team is now complete. It may be appreciated that other methods for soliciting a user's decision may be used. The stopping criterion may include the team reaching a predefined maximum team size. Alternatively, the stopping criterion may include determining that knowledge and target criteria have been met based on generating scores corresponding with the evidence values of the selected sellers making up the team and comparing the scored evidence values to predefined target values.

If the team recommendation program 110a and 110b determined that the team is complete, then the team recommendation program 110a and 110b may end. However, if the team recommendation program 110a and 110b determined that the team is not complete, then the team recommendation program 110a and 110b may return to 308 to prompt the user to select another team role to fill. Thus, the user may fill the roles of the team iteratively until a complete team has been selected to form the basis for the team recommendation. The team recommendation may then be presented to the user, sent to another person (e.g., a manager), or sent to another program for processing or other use.

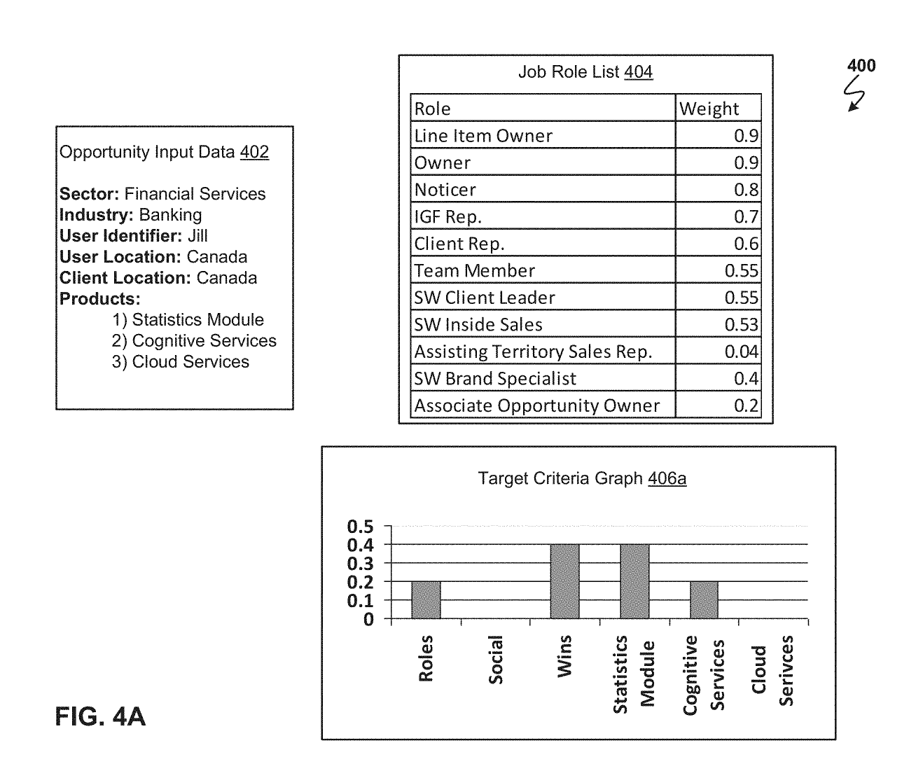

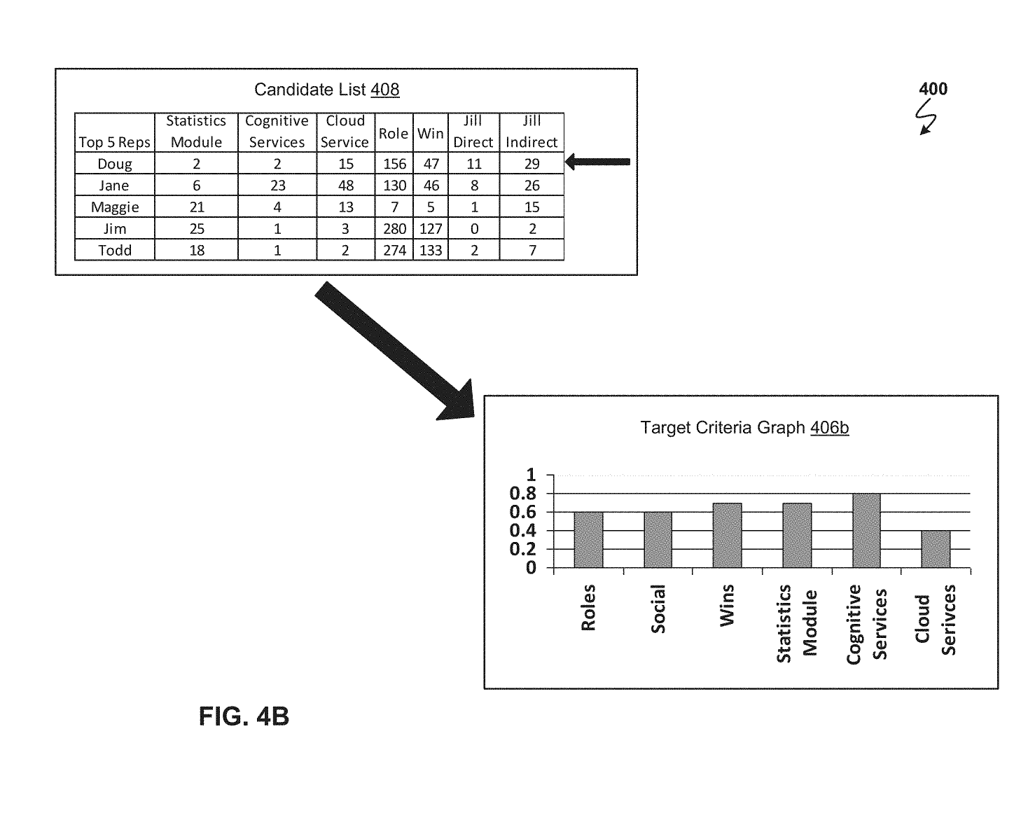

Referring now to FIGS. 4A and 4B, an exemplary team building model usage scenario 400 illustrating the recommendation model usage process 300 according to at least one embodiment is depicted.

In FIG. 4A, the opportunity input data 402 is entered by the user Jill. As shown, Jill has entered the sector, industry, user identifier, user location, client location, and products involved with the current opportunity as described previously at 302. Based on the opportunity input data 402, the ranking engine 214 is queried as described previously at 304. Based on the results of the query, job roles are identified and a group of job roles are identified and weighted as described previously at 306. The group of weighted job roles is then organized as a ranked job role list 404 and presented to the user as described previously at 308. As shown, the weights assigned to the job roles may also be displayed to the user in the job role list 404. Jill then may interact with the job role list 404 to select a role to fill by clicking on the Line Item Owner role.

According to at least one embodiment, the target criteria of the team for the current opportunity described in the opportunity input data 402 may be shown in a target criteria graph 406a. The target criteria graph 406a may show criteria such as roles, wins, products and the current values indicating the experience of the current team collectively with respect to the criteria. The values shown in target criteria graph 406a indicates the current team (which includes Jill initially) has a collective roles value of 0.2, a collective social value of 0.0, a collective wins value of 0.4, a collective Statistics Module experience value of 0.4, a collective Cognitive Services experience value of 0.2, and a collective Cloud Services value of 0.0. The target criteria graph 406a may be shown to the user when selecting a user role at 308 or when the user selects a candidate at 316.

Thereafter, as shown in FIG. 4B, the candidate list 408 is generated based on a query to the ranking engine 214 as described previously at 314. The candidates for the selected role of Line Item Owner are displayed to Jill in the candidate list 408 as described previously at 316. If Jill selects Doug from the candidate list 408 by clicking on the row for Doug, Doug will be selected to fill the role of Line Item Owner as described previously at 318. Thereafter, an updated target criteria graph 406b is generated based on Jill and Doug as members of the current team and Jill may iteratively select additional job roles and additional candidates to fill the job roles until Jill feels the team is complete or some other stopping criterion is met.

It may be appreciated that FIGS. 2-4 provide only an illustration of one embodiment and do not imply any limitations with regard to how different embodiments may be implemented. Many modifications to the depicted embodiment(s) may be made based on design and implementation requirements. The above embodiments are described in the context of building a team for a sales opportunity, however, it may be appreciated that different embodiments may be used in different contexts for forming a team of people for a project or assignment.

FIG. 5 is a block diagram 900 of internal and external components of computers depicted in FIG. 1 in accordance with an illustrative embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902a, b and external components 904a, b illustrated in FIG. 5. Each of the sets of internal components 902a, b includes one or more processors 906, one or more computer-readable RAMs 908, and one or more computer-readable ROMs 910 on one or more buses 912, and one or more operating systems 914 and one or more computer-readable tangible storage devices 916. The one or more operating systems 914, the software program 108 and the team recommendation program 110a in client computer 102, and the team recommendation program 110b in network server 112, may be stored on one or more computer-readable tangible storage devices 916 for execution by one or more processors 906 via one or more RAMs 908 (which typically include cache memory). In the embodiment illustrated in FIG. 5, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the team recommendation program 110a and 110b can be stored on one or more of the respective portable computer-readable tangible storage devices 920, read via the respective R/W drive or interface 918, and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the team recommendation program 110a in client computer 102 and the team recommendation program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the team recommendation program 110a in client computer 102 and the team recommendation program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904a, b can also include touch screens, virtual keyboards, touch pads, pointing devices, and other human interface devices. Each of the sets of internal components 902a, b also includes device drivers 930 to interface to computer display monitor 924, keyboard 926, and computer mouse 928. The device drivers 930, R/W drive or interface 918, and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

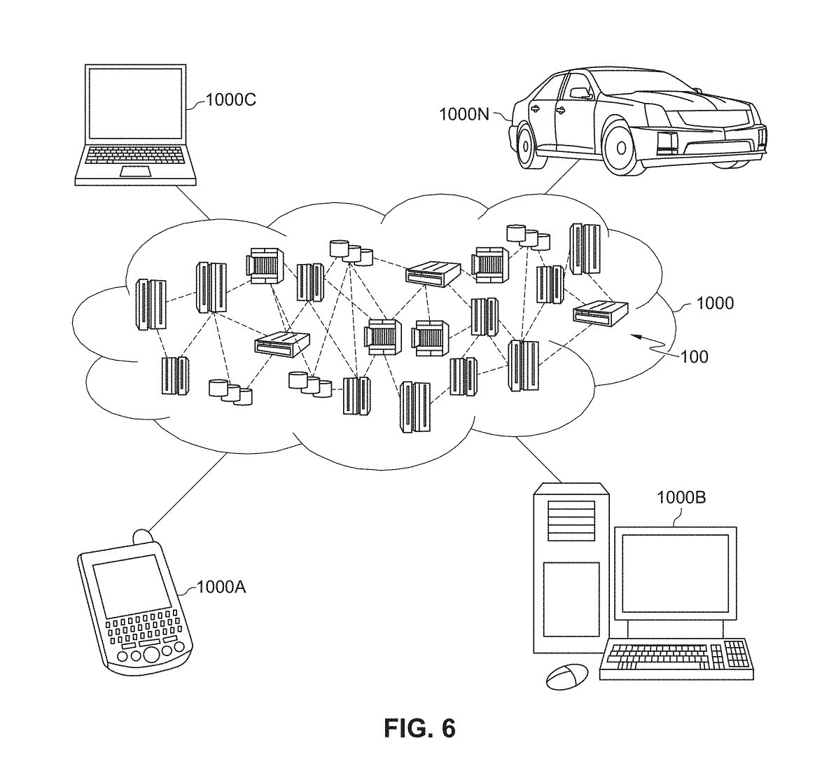

Referring now to FIG. 6, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 6 are intended to be illustrative only and that computing nodes 100 and cloud computing environment 1000 can communicate with any type of computerized device over any type of network and/or network addressable connection (e.g., using a web browser).

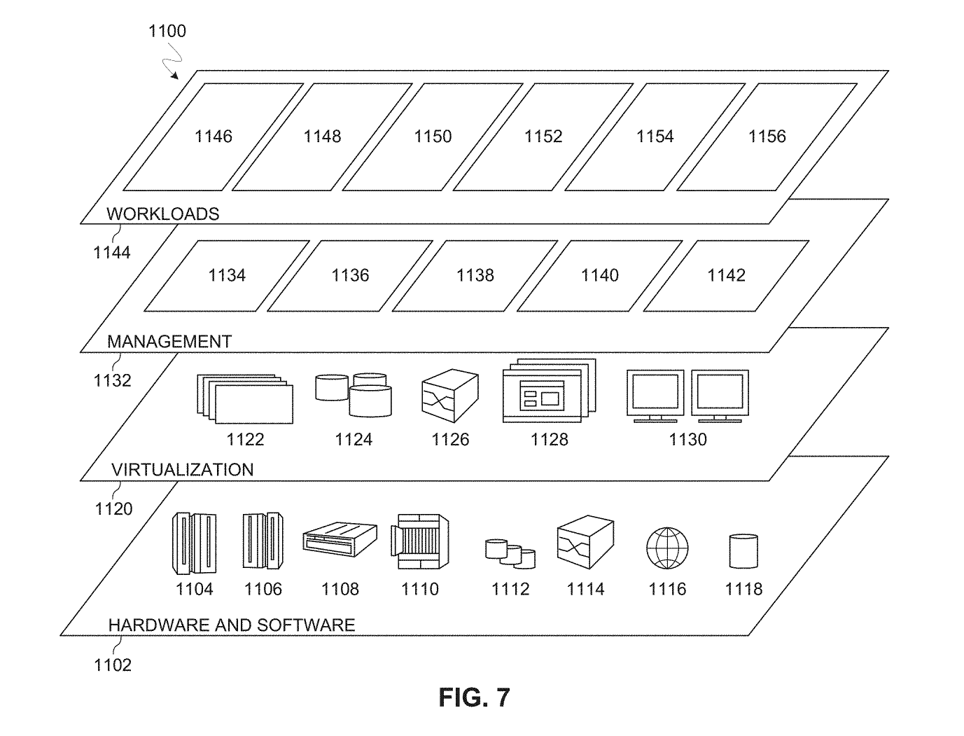

Referring now to FIG. 7, a set of functional abstraction layers 1100 provided by cloud computing environment 1000 is shown. It should be understood in advance that the components, layers, and functions shown in FIG. 7 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and team recommendation 1156. A team recommendation program 110a, 110b provides a way to iteratively build and recommend a team for working on a project.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for building a team to work on an opportunity, the method comprising:
receiving an opportunity signature based on the opportunity;
determining a plurality of team roles based on the received opportunity signature;
selecting a role to fill from the determined plurality of team roles;
determining a plurality of candidates based on the selected role and the received opportunity signature, wherein the plurality of candidates includes a plurality of candidate evidence data;
selecting a candidate from the determined plurality of candidates based on the plurality of candidate evidence data;
assigning the selected candidate to fill the selected role on the team; and
iteratively selecting at least one additional role and at least one additional candidate to fill the selected at least one additional role on the team until a stopping criterion is met.

2. The method of claim 1, further comprising:
requesting a plurality of prior opportunity data from an historical database;
receiving the requested plurality of prior opportunity data, wherein the received plurality of prior opportunity data includes a plurality of team member data;
extracting a plurality of social network data from the plurality of team member data;
extracting a plurality of opportunity feature data from the plurality of team member data;
generating an evidence-based model from the extracted plurality of social network data and the extracted plurality of opportunity feature data; and
storing the generated evidence-based model in a ranking engine.

3. The method of claim 2, wherein the plurality of team member data is selected from the group consisting of a plurality of prior job role data, a plurality of product knowledge data, a plurality of social relationship data, and a plurality of prior performance data.

4. The method of claim 2, wherein determining the plurality of team roles based on the received opportunity signature comprises analyzing the plurality of prior opportunity data to determine a set of roles used in a subset of prior opportunities associated with the plurality of prior opportunities that had a successful result, wherein the subset of prior opportunities are analyzed and the set of roles are assigned a weight value indicating an importance of the set of roles in achieving the successful result, and wherein the determined plurality of team roles is based on the set of roles and assigned weights.

5. The method of claim 4, wherein selecting the role to fill from the determined plurality of team roles comprises presenting the determined plurality of team roles to a user and, in response to receiving a user role selection based on the presented plurality of team roles, selecting the role to fill from the user role selection.

6. The method of claim 1, wherein the plurality of candidate evidence data is selected from the group consisting of a product knowledge value, a successful performance value, a direct social contact value, and indirect social contact value, and a number of roles held value.

7. The method of claim 2, wherein determining the plurality of candidates based on the selected role and the received opportunity signature comprises retrieving the plurality of candidates from the generated evidence-based model by sending a query to the ranking engine, wherein the sent query is created based on the selected role and the received opportunity signature.

8. The method of claim 4, wherein selecting the candidate from the determined plurality of candidates comprises presenting the determined plurality of candidates to a user and, in response to receiving a user candidate selection based on the presented plurality of candidates, selecting the candidate from the user candidate selection.

9. A computer system for building a team to work on an opportunity, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving an opportunity signature based on the opportunity;
determining a plurality of team roles based on the received opportunity signature;
selecting a role to fill from the determined plurality of team roles;
determining a plurality of candidates based on the selected role and the received opportunity signature, wherein the plurality of candidates includes a plurality of candidate evidence data;
selecting a candidate from the determined plurality of candidates based on the plurality of candidate evidence data;
assigning the selected candidate to fill the selected role on the team; and
iteratively selecting at least one additional role and at least one additional candidate to fill the selected at least one additional role on the team until a stopping criterion is met.

10. The computer system of claim 9, further comprising:
requesting a plurality of prior opportunity data from an historical database;
receiving the requested plurality of prior opportunity data, wherein the received plurality of prior opportunity data includes a plurality of team member data;
extracting a plurality of social network data from the plurality of team member data;
extracting a plurality of opportunity feature data from the plurality of team member data;
generating an evidence-based model from the extracted plurality of social network data and the extracted plurality of opportunity feature data; and
storing the generated evidence-based model in a ranking engine.

11. The computer system of claim 10, wherein the plurality of team member data is selected from the group consisting of a plurality of prior job role data, a plurality of product knowledge data, a plurality of social relationship data, and a plurality of prior performance data.

12. The computer system of claim 10, wherein determining the plurality of team roles based on the received opportunity signature comprises analyzing the plurality of prior opportunity data to determine a set of roles used in a subset of prior opportunities associated with the plurality of prior opportunities that had a successful result, wherein the subset of prior opportunities are analyzed and the set of roles are assigned a weight value indicating an importance of the set of roles in achieving the successful result, and wherein the determined plurality of team roles is based on the set of roles and assigned weights.

13. The computer system of claim 12, wherein selecting the role to fill from the determined plurality of team roles comprises presenting the determined plurality of team roles to a user and, in response to receiving a user role selection based on the presented plurality of team roles, selecting the role to fill from the user role selection.

14. The computer system of claim 9, wherein the plurality of candidate evidence data is selected from the group consisting of a product knowledge value, a successful performance value, a direct social contact value, and indirect social contact value, and a number of roles held value.

15. The computer system of claim 10, wherein determining the plurality of candidates based on the selected role and the received opportunity signature comprises retrieving the plurality of candidates from the generated evidence-based model by sending a query to the ranking engine, wherein the sent query is created based on the selected role and the received opportunity signature.

16. A computer program product for building a team to work on an opportunity, comprising:
one or more computer-readable storage media and program instructions stored on at least one of the one or more tangible storage media, the program instructions executable by a processor to cause the processor to perform a method comprising:
receiving an opportunity signature based on the opportunity;
determining a plurality of team roles based on the received opportunity signature;
selecting a role to fill from the determined plurality of team roles;
determining a plurality of candidates based on the selected role and the received opportunity signature, wherein the plurality of candidates includes a plurality of candidate evidence data;
selecting a candidate from the determined plurality of candidates based on the plurality of candidate evidence data;
assigning the selected candidate to fill the selected role on the team; and
iteratively selecting at least one additional role and at least one additional candidate to fill the selected at least one additional role on the team until a stopping criterion is met.

17. The computer program product of claim 16, further comprising:
requesting a plurality of prior opportunity data from an historical database;
receiving the requested plurality of prior opportunity data, wherein the received plurality of prior opportunity data includes a plurality of team member data;
extracting a plurality of social network data from the plurality of team member data;
extracting a plurality of opportunity feature data from the plurality of team member data;
generating an evidence-based model from the extracted plurality of social network data and the extracted plurality of opportunity feature data; and
storing the generated evidence-based model in a ranking engine.

18. The computer program product of claim 17, wherein the plurality of team member data is selected from the group consisting of a plurality of prior job role data, a plurality of product knowledge data, a plurality of social relationship data, and a plurality of prior performance data.

19. The computer program product of claim 17, wherein determining the plurality of team roles based on the received opportunity signature comprises analyzing the plurality of prior opportunity data to determine a set of roles used in a subset of prior opportunities associated with the plurality of prior opportunities that had a successful result, wherein the subset of prior opportunities are analyzed and the set of roles are assigned a weight value indicating an importance of the set of roles in achieving the successful result, and wherein the determined plurality of team roles is based on the set of roles and assigned weights.

20. The computer program product of claim 19, wherein selecting the role to fill from the determined plurality of team roles comprises presenting the determined plurality of team roles to a user and, in response to receiving a user role selection based on the presented plurality of team roles, selecting the role to fill from the user role selection.
